(19) United States
(12) Patent Application Publication
(10) Pub. No.: US 2011/0129580 A1
(43) Pub. Date: Jun. 2, 2011

(54) METHOD OF AGING BLACK GARLIC

(75) Inventors: YONG DUCK KO, Changwon-si (KR); YOO HAN KO, Changwon-si (KR); YOO SUNG KO, Changwon-si (KR)

(73) Assignee: Saenamhae Nonghyup, Gyeongsangnam-do (KR)

(21) Appl. No.: 12/823,367

(22) Filed: Jun. 25, 2010

(30) Foreign Application Priority Data
Dec. 1, 2009 (KR) 10-2009-0117567

(51) Int. Cl. A23L 1/212

(52) U.S. Cl. 426/419

(57) ABSTRACT

Provided is a method of aging black garlic, which in an embodiment involved the following procedures: classifying the garlic according to its condition and pre-treating it to achieve clean appearance; sealing the garlic in a vinyl pack by 10 kg and storing it in a tray; putting said tray in an aging device for a black garlic, applying steam and heat for 1˜3 hrs while maintaining a temperature of 80˜100° C. inside the aging device, and treating by steam under a high temperature and high humidity condition; main aging by applying steam and heat to the treated garlic for 198 hrs while maintaining a temperature of 72˜78° C. inside the aging device; after-aging by applying steam and heat to the garlic, which had undergone main aging process, for 35 hrs while maintaining 60˜69° C. temperature inside the aging device; drying the after-aged garlic for 51 hrs while maintaining a temperature of 50˜58° C. inside the aging device; and low temperature after-aging by cooling said dried garlic at low temperature for 168 hrs while maintaining 0˜5° C. temperature inside the aging device. Provided is a method of aging black garlic characterized by drawing optimum time and condition without taking the storage condition, size, etc. of the garlic.

### CROSS-REFERENCE TO RELATED APPLICATION

The present application claims the benefit under 35 U.S.C. §119 of Korean Patent Application No. 10-2009-0117567, filed Dec. 1, 2009, which is hereby incorporated by reference in its entirety.

### BACKGROUND OF THE INVENTION

1. Field of the Invention

The present invention relates to a method of aging black garlic.

2. Description of the Related Art

The garlic (Allium sativum L.) is a perennial bulb plant, which belongs to Lily and Allium family, and is generally effective in preventing diseases and recovering health from cerebral infarction, hypertension, and atherosclerosis; promoting blood circulation; a settling the nerves; disinfestations; and has sterilization effect. Recently, a study revealed that sulphur amino acids and their derivatives, etc. have the characteristics of detoxifying toxicity and inhibiting heavy metal poisoning; for example, it can suppress the absorption of a heavy metal at a digestive tract. The vitamin B1, known as anti-fatigue vitamin, becomes allithiamine by acting with the garlic, speeding up metabolism. Like vitamin B1, it helps in fatigue recovery and stamina improvement.

However, an allicin, known as the unique scent compound of the garlic that is produced by breaking down an alliin (the principal ingredient of the garlic with alliinase) such as crushing it from the garlic tissue, causes bad breath. Because of this, eating edible food with such excellent effectiveness as the garlic is avoided.

In the case of aging the garlic at a constant temperature and humidity without adding any additives to raw garlic, an anti-oxidant ability is largely increased, compared to raw garlic, without decreasing the original effectiveness of the garlic. S-aryl cysteine material, which does not exist in raw garlic, is produced, making the aged garlic high in polyphenol content. As regards the earlier arts of aging garlic, Korean Patent Registration No. 0530386 discloses a method of aging garlic, which is comprised of aging raw garlic by hot-air for about 300 hrs at 40˜90° C., naturally drying them for about 40 hrs, and aging them for 30˜50 hrs by hot-air with 20˜30° C. temperature. This invention relates only to hot-air drying at a constant condition. While this process is able to age garlic, the flavor and texture of final product are inferior.

### BRIEF DESCRIPTION OF THE DRAWINGS

FIG. 1 is a front drawing of the black garlic aging device that is used in the implementation of the invention.

FIG. 2 is an inner skew drawing of the black garlic aging device that is used in the implementation of the invention.

FIG. 3 is a front drawing of the inner structure of the aging chamber of the black garlic aging device that is used in the implementation of the invention.

FIG. 4 is a drawing of the tray structure of the black garlic aging device that is used in the implementation of the invention.

FIG. 5 is a block drawing showing roughly the constitution of Radio-Frequency Identification (RFID) system that used piezoelectrics of the black garlic aging device, which is used in the implementation of the invention.

FIG. 6 shows the aging process of the black garlic by temperature and by step, based on the present invention's example.

FIG. 7 shows the change of the temperature and humidity of the black garlic by step, based on the present invention's example.

FIG. 8 is a flow chart showing the manufacturing process based on the example of the present invention.

### BRIEF DESCRIPTION OF THE DRAWING MARKS

10 black garlic aging device
100 aging chamber
200 control chamber
210 control part
220 large-capacity steam generator
230 compressor
300 tray
400 host
500 weight sensor
510 piezoelectrics
520 IC Chip
530 tag antenna
600 Reader
610 reader antenna
620 analog signal processing part
630 digital signal processing part
700 heating device
800 temperature sensor
900 humidity sensor

### TECHNICAL SOLUTION

To solve said problems, an aspect of the present invention provides a method for aging the black garlic in such a way that the black garlic can be used as a high-quality functional healthy food, holding the unique and natural nutrients of garlic.

Aiming to achieve said purpose, a method of aging black garlic is invented, which involves classifying the garlic based on its condition and pre-treating it for clean appearance; sealing the garlic in a vinyl pack by 10 kg and storing it in a tray; putting said tray into an aging device for black garlic, applying steam and heat for 1˜3 hrs while maintaining a temperature of 80˜100° C., and treating it by steam under a high-temperature and high-humidity condition. Main aging is done by applying steam and heat for 198 hrs to the said treated garlic while maintaining a temperature of 72˜78° C. in the aging device. After-aging is done by applying steam and heat to the said main aged garlic for 35 hrs while maintaining 60˜69° C. in the aging device. The after-aged garlic is dried for 51 hrs while temperature in the aging device is kept between 50˜58° C. Low temperature after-aging is done by cooling said dried garlic at low temperature for 168 hrs, maintaining 0˜5° C. temperature in the aging device. There is also a method of aging black garlic, which is characterized by drawing an optimum time and condition without taking the storage condition, size, and other characteristics of the garlic.

### EFFECTIVENESS OF INVENTION

By aging black garlic comprising said constitution according to the methods described in the present invention, the time and aging process can be optimized by optimizing the condition for aging of the inner part of the aging chamber, by equipping with a sensor for temperature, humidity, and weight, an inner portion of the black garlic aging device.

### EMBODIMENTS OF THE INVENTION

Exemplary embodiments of the present invention will now be described in detail through the accompanying drawings. However, the present invention will not be limited by the above-mentioned embodiments; other embodiments, which is involved in the spirit and scope of the present invention or other retrogressive invention will be provided by addition, modification, deletion, etc. of other constituents.

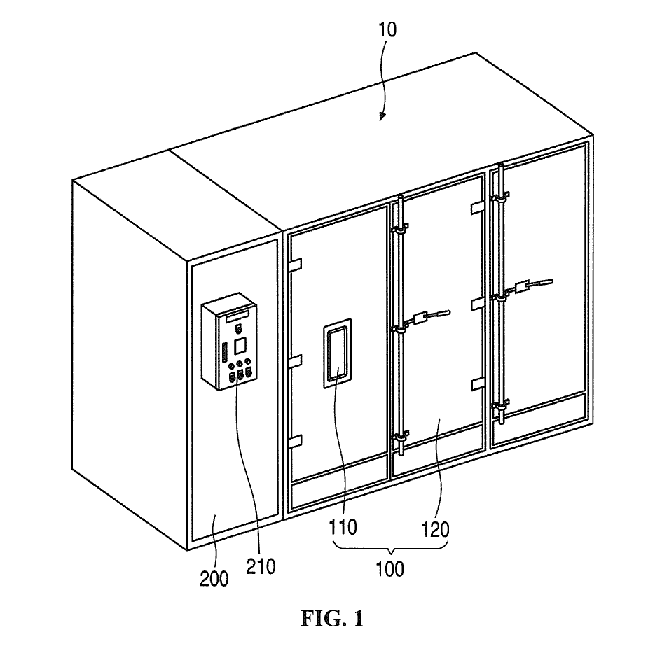

In FIG. 1, the black garlic aging device 10, which is used in carrying out the present invention, is equipped with an aging chamber 100 where a plural tray 300 for storing the garlic for aging is stored therein; and a control chamber 200 that is equipped in one side of said aging chamber 100. Heat, steam and chilly air are provided into said aging chamber 100, thereby the appearance is formed.

The appearance of said aging chamber 100 is devided from side to side by the door 120; one side of said door 120 is equipped with a checking window 110 where the inner condition of said aging chamber 100 can be checked.

Further, the door 120 that selectively shields said aging chamber 100 is installed into said aging device 10 by a hinge joint. The said door 120 seals said aging chamber 100 by a door contract opening from outer circumstance.

Further, a control part 210 where the inner condition, such as the temperature, humidity, etc., of the inner part of said aging chamber 100 is displayed, and a large-capacity steam generator 220 and a compressor 230 are operated and controlled therein, is equipped in front of said control chamber 200.

On the other hand, a ventilating shutter 140 for releasing the heat and moisture, by maintaining humidity and temperature generated in said aging chamber 100, and for releasing the sulphur gas out, is equipped in the upper side of said aging chamber 100.

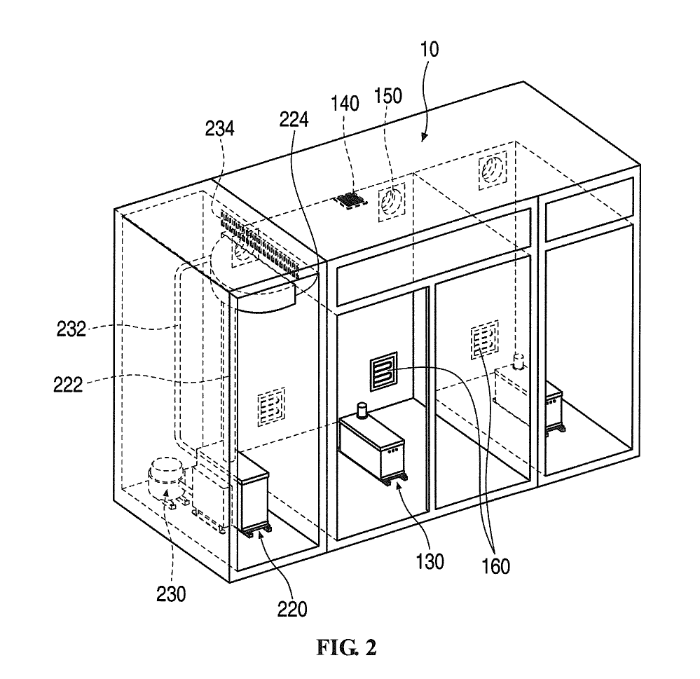

FIG. 2 is an inner skew drawing of the inner structure of the black garlic aging device 10, which is used in the example of the present invention.

In FIG. 2, in order to provide the heat and steam and chilly air required by each aging process, a large-capacity steam generator 220 and a compressor 230 for generating chilly air are equipped in the control chamber 200, which is located at left of said black garlic aging device 10.

In detail, the steam which is generated through said large-capacity steam generator 220 is discharged into the steam opening, which is formed at the upper side of the aging chamber 100 via a duct for the steam, which is funneled upward.

The said steam is supplied downward into the inner part of the aging chamber 100, heating the tray 300 that holds the garlic for aging, and therefore, providing steam to the garlic.

Throughout the final stage of the black garlic aging process, the inner of the aging chamber 100 maintains a cool low-temperature condition for a long time in order to maintain the gummy tissue-like quality of the aged black garlic. At this process stage, the compressor 230 for chilly air which is equipped in said control chamber 200 is operated.

The chilly air generated by the compressor 230 is discharged into the aging chamber 100 via a chilly wind hole which is formed at the upper side of the aging chamber 100 and a duct for chilly air connected upward.

The aging chamber 100 is located at the side of the control chamber 200.

The aging chamber 100 is composed of the tray guide 180, which holds home-position and guides the forward-backward withdraw-incoming movement of the inner of multiple trays 300 where garlic is stored; and the steam generator 130, which is equipped at the inner bottom of the aging chamber 100, generating steam in order to maintain reasonable inner humidity and temperature required for each aging stage.

Referring to the drawings, the hot air hole 150 is equipped at the upper rear side of the aging chamber 100, and an electric heater 160, at the lower side.

Further, a ventilating shutter 140 is equipped at the inner topside of the aging chamber 100.

The amount of steam generated, the steam generation time, the start and end of steam generation, etc. of the steam generator 130 are controlled by the control part 210.

On the other hand, an electric heater 160 is equipped at the lower rear side of the aging chamber 100.

The said electric heater 160 is the heat source adapting the inner temperature of the aging chamber 100 to that required for each aging stage. The control of its operation and calculation of calorie, etc. is supervised by the control part 210.

Next, at the upper rear side of the aging chamber 100, the hot air hole 150 is installed, into which the heat generated by the heating device 700 passes, passing through the connected duct 720.

With the hot wind flowed from the inner upper part of the aging chamber 100 through the hot air hole 150 and the double heat source supplied by the lower part of the aging chamber 100, the temperature required for the garlic to be aged at each stage is controlled to be constant regardless of the inner temperature deviation of the aging chamber 100.

On the other hand, the ventilating shutter 140 is equipped at the inner upper side part of the said aging chamber 100.

The ventilating shutter 140 is the device forcing to emit the sulphur gas generated during the garlic aging process and the unnecessary humidity and heat source generated at each stage.

On the other hand, at one side of the rack 80, the temperature sensor 800, which measures the inner temperature of the aging chamber 100 and sends the data to the host 400, is located.

The said temperature sensor 800 is attachable to or removable from one side of the aging chamber 100 or the tray 300, and can be connected to the host 400 in a wired or wireless manner.

In addition, in order to measure the humidity inside the aging chamber 100, the humidity sensor 900 is installed at one side of the aging chamber 100 or the tray 300; the measured inner humidity is sent to the host 400.

The humidity sensor 900 is attachable to or removable from the tray 300, etc., and connected to the host 400 in a wired or wireless manner.

Also, between one side of the lower side of the tray 300 and the tray guide 180, the weight sensor 500 is installed. This measures the weight change between the initial weight of the garlic stored at the said tray 300 and the weight when measured during the aging process, and sends the data to the host 400.

The weight sensor 500 also has an attachable or removable structure, and is connected to the control part 210 in a wired or wireless manner.

Further, at the lower part inside the aging chamber 100 is the steam generator 130 that generates steam to keep the humidity inside the aging chamber 100 constant.

On the other hand, the heat generated through the heating device 700 equipped at the rear side of the aging chamber 100 is flowed into the inside of the chamber through the hot air hole 150 connected to the duct.

The operation of the steam, heat and chilly air generators can be automatically controlled by the host 400 connected in a wired or wireless manner, or through the operator's manual handling of the control part 210.

On the other hand, at the upper part of the aging chamber 100, the ventilating shutter connected to the ventilating hole formed inside the aging chamber 100 is provided.

The ventilating shutter emits the heat, steam and sulphur gas generated inside the aging chamber 100. The opening and closing of the ventilating shutter can be operated manually, and the opening and closing of the motor, etc. can be automatically controlled by the wired or wireless signal of the host 400.

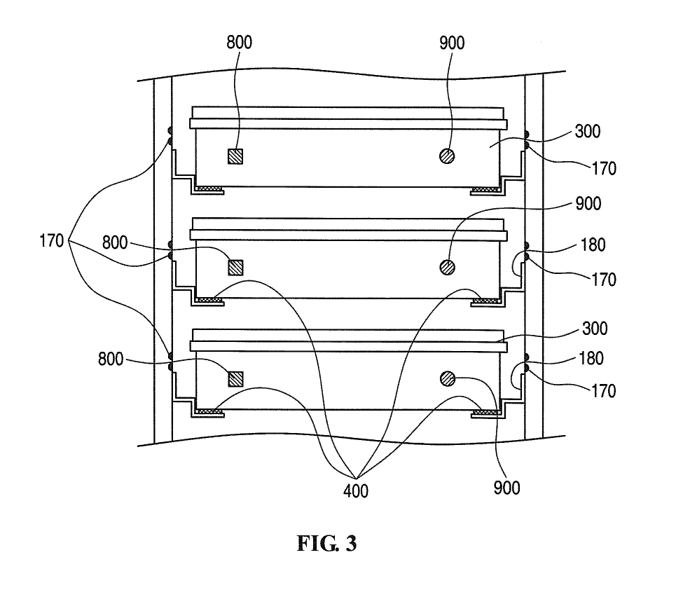

FIG. 3 is the drawing about the installation of the weight sensor 500 of the black garlic aging device 10 required for the embodiment of the present invention.

As shown in the drawing, the tray guide 180, vertically strained and formed twice at the left and right inner sides of the aging chamber 100, is equipped at each corresponding position.

The side steam hole 170 has a structure connected to the large capacity steam generator 220 and the duct 222 inside the control chamber 200.

Between the tray 300 and the tray guide 180 is a contact surface of constant area forms where the weight sensor 500 is located. The installed weight sensor 500 measures the change in total weight of each tray 300 at each stage and sends data to the host 400. The aging stage is continued according to the weight change of the tray 300 sent to the host 400.

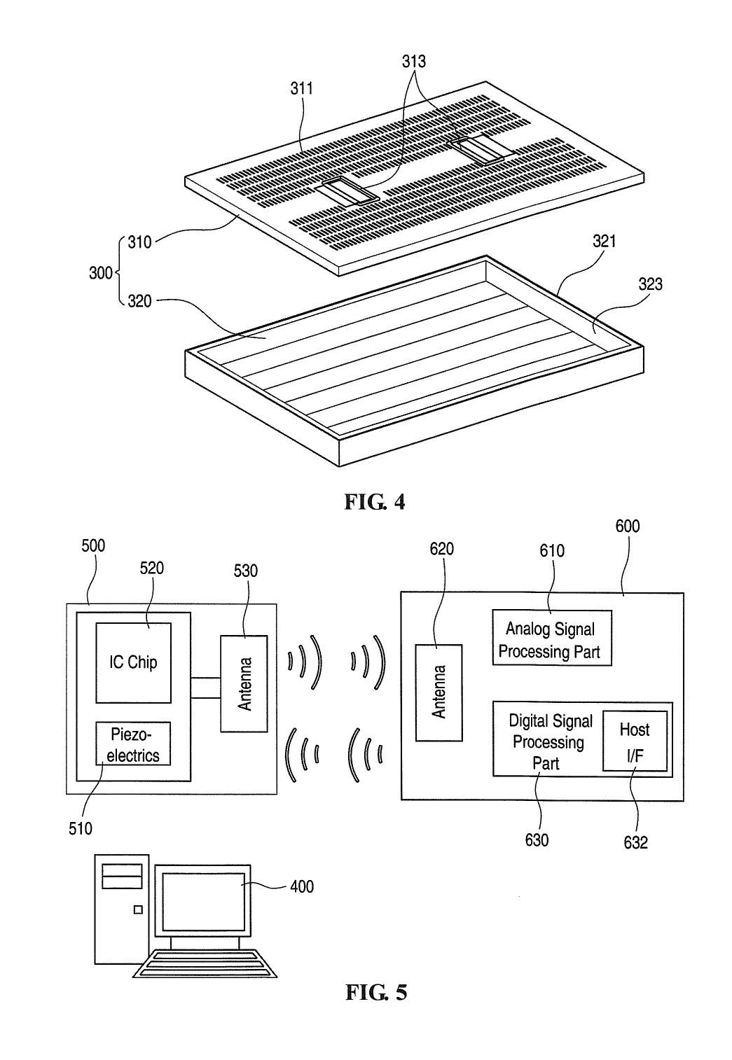

FIG. 4 is a drawing about the structure of the tray 300 of the black garlic aging device 10 required for the embodiment of the present invention. As shown in the drawing, the tray 300 is composed of the cover part 310 and the storage part 320. The long hole type of many ventilating holes 311 are formed at the upper side of the cover part.

Further, jointed on the cover part 310 is a handle 313 hinge, which makes the cover part 310 easy to assemble for the operator's operating convenience.

FIG. 5 is a block drawing showing roughly the constitution of the Radio-Frequency Identification (RFID) system that uses piezoelectrics of the black garlic aging device 10, which is used in the embodiment of the invention.

As shown in the drawing, the Radio-Frequency Identification (RFID) system using piezoelectrics of the present invention is composed of a weight sensor 500, a reader 600, and a host 400, among others.

The weight sensor 500 is in charge of storage and sending of the information, and consists of a tag antenna 530 for sending/receiving radio-frequency identification data, an IC Chip 520 for the storage and control of the information, and a piezoelectrics generating power.

The tag antenna 530 is equipped at one side of the weight sensor 500; it sends off and receives data by RF (Radio Frequency) signal with the reader 110, and comes in various shapes depending on the purpose or use.

Said RF signal enables the long distance transmission by radio-frequency of 1 GHz or lower in general.

The IC chip 520 is in charge of storage of the information. It receives electric power from the piezoelectrics 510 and controls the sending/receiving circuit. It is equipped at the inner of the weight sensor 500.

The reader 600 consists of a reader antenna 610, an analog signal processing part 620, a digital signal processing part 630, and a host interface 632, among others. It translates the data received from the weight sensor 500 and controls the radio-frequency sending.

The reader antenna 610 is equipped at one side of the reader 600; as the tag antenna 530, it performs the function of sending and receiving data by RF (Radio Frequency) signal and comes in various types according to the purpose or use.

The analog signal processing part 620 is equipped inside the reader 600, consisting of Low Noise Amplifier (LAN) that reduces the received noise, and a demodualtor that performs the process of restoring the modified signal to original signal (not shown in the illustration).

The digital signal processing part 630, equipped inside the reader 600, is composed of a host interface 632, a transmission and reception standard clock generator that sets transmission and reception standard speed by generating a standard clock, a decoder that switches the digital signal to the analog data, and a digital processor that calculates data arithmetically/logically, among others.

The host 400 consists of a computer or an outer device. It processes and stores the data received from the reader 600; and sends data back to it when necessary. In order to process a large quantity of data received from many readers, the host 400 serves as the agent-based dispersion network system.

As described above, a black aging device 10 using Radio-Frequency Identification (RFID) system can guarantee the uniform quality of the black garlic, shorten the prolonged aging time, and reduce the amount of electric power required for aging of the black garlic.

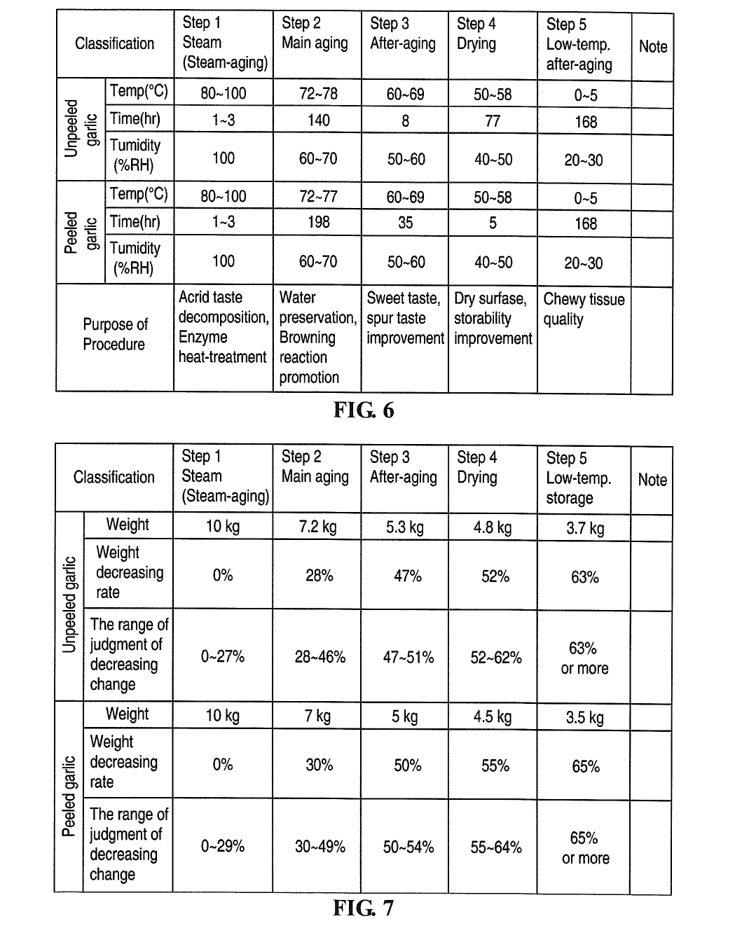

FIG. 6 is a table showing the black garlic aging procedure by temperature and stage according to the present invention's method of aging black garlic. FIG. 7 is a table showing the temperature, time, and humidity of the unpeeled and peeled garlic by step according to the example of the present invention.

The manufacturing procedure of the black garlic according to its method of preparation, as shown by the present invention's example, is divided into five steps.

Primarily, as a pre-treating procedure, the raw garlic must be prepared by distinguishing garlic with the same condition.

After the preparation for aging as above is completed, the inner temperature and humidity of the aging chamber and the weight of the stored garlic are checked; furthermore, the information must be confirmed.

After the abovementioned preparations, the black garlic is manufactured through the following five steps. Below as an example is the case of the peeled garlic.

Initially, preparatory steps are performed: the peeled garlic is stored by 10 kg, sealed, and stored at each tray.

Step 1: the prepared garlic is steam-treated at a high temperature and high humidity condition.

In this procedure, steam and heat are applied for 1˜3 hrs while maintaining the temperature of 80˜100° C. At this time, the humidity condition must be maintained at 100% RH. By this procedure, heat and water produced from the steam are applied to the garlic, making the tissue of the garlic smooth and soft.

The water in these garlic is later changed in phase to steam, and discharged into outer air. Thus, the weight of the garlic is decreased. If the weight change of the garlic is about 0˜29%, the steam processing is finished, and the next step is carried out. Once this step is finished, the hot taste of the garlic is broken down; the hard tissue of the garlic becomes smooth and soft because of the heat-treating action of the enzyme inside of the garlic.

In the next main aging step, heat is applied by the temperature of 72˜77° C.; the inner humidity is maintained at 60˜70% RH for about 198 hrs. After this main aging procedure is finished, the weight change of the garlic becomes about 30˜49%.

Through this procedure, the garlic preserves a constant amount of water in its tissue. At this stage, the browning reaction is promoted.

After the main aging procedure is finished, the after-aging procedure is begun.

In the after-aging procedure, the temperature of 60˜69° C. is maintained; the humidity condition is maintained at 50˜60% RH for 35 hrs. By maintaining these conditions, the hot taste of the garlic disappears, and good sugar content with the sweet and sour taste good for eating develops.

The next step is the drying. This step is done by maintaining a temperature of 50˜58° C., and humidity condition of 40˜50% RH for 51 hrs. After this step, the surface of the black garlic becomes dry. Thus, each particle of the black garlic is not sticky as it was, as caused by the water and resin in the surface. The garlic becomes gentler to consumer's hands, and Handling it is now easy owing to its non-sticky quality. Storability is also improved.

Next, the low temperature after-aging follows. At this stage, the temperature is maintained at 0˜5° C., and the humidity condition at 20˜30% RH for 168 hrs. By keeping these required conditions, the chilly air is supplied into the inner of the aging chamber using the chilly air compressor that is installed in the aging device.

With the supplied chilly air, garlic is kept at a low-temperature.

Once the after-aging step is finished, the best black garlic is produced. Its surface is dry; its inner part is chewy due to proper water content; its taste, sweet and sour; and its handling and storability, easier.

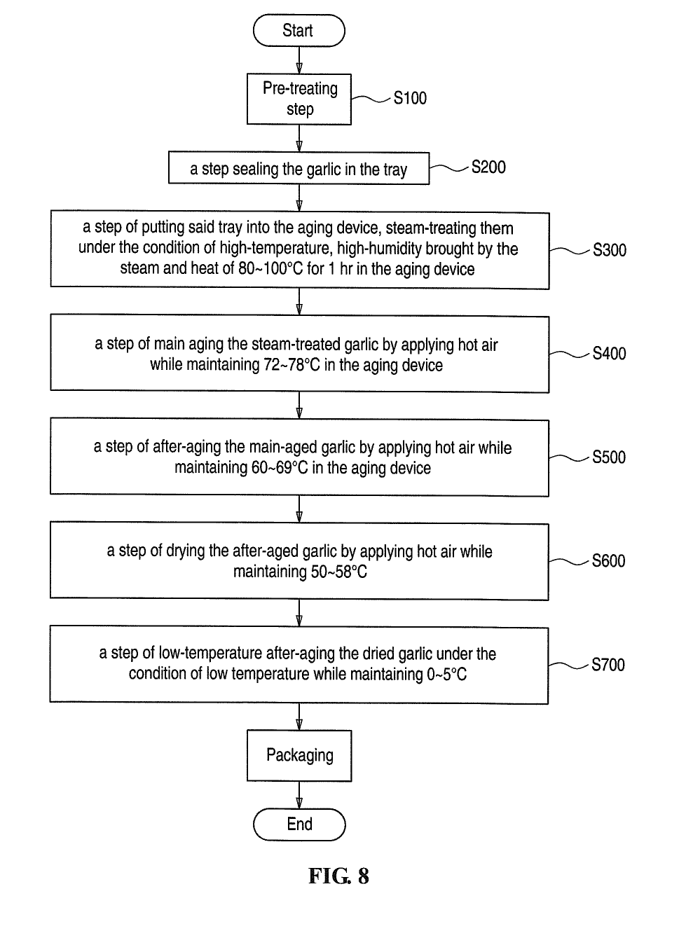

FIG. 8 is a flow chart showing the manufacturing process based on the present invention.

In detail, the aging process begins with a pre-treating procedure.

In this procedure, the garlic is divided and prepared into the unpeeled and peeled garlic types.

Next, the garlic is stored in a vinyl pack, each having 10 kg of garlic; sealed; and stored in each tray.

Next, the steam-treating step is done. In the case of peeled garlic, the inner of the aging chamber is maintained at a temperature of 85˜100° C. and humidity of 100% RH for 1˜3 hrs; in so doing, the garlic is steam-aged. Through this step, the garlic loses the hard tissue quality due to the heat and steam; the hot taste component of the raw garlic is likewise emitted outside the aging chamber.

Next, the main aging procedure is done. After steam-treating the garlic, the inner part of the aging chamber is kept at a temperature of 72˜77° C. and humidity of 60˜70% RH for 198 hrs. By means of this, the water of the garlic is preserved and the browning reaction is promoted.

Next, the after-aging procedure follows. In this step, the inner part of the aging chamber is maintained at a temperature of 60˜69° C. and humidity of 50˜60% RH for 35 hrs.

At this stage, the hot taste of the garlic is eliminated; the sweet and sour taste is promoted.

Next, the drying procedure is done. The inner part of the aging chamber is maintained at a temperature of 50˜58° C. and humidity of 40˜50% RH for 51 hrs.

After this step, the inner part of the aged black garlic preserves water and the surface becomes dry; thus, its handling and storability becomes easy.

Finally, the low-temperature after-aging step is done. In this step, the inner part of the aging chamber is maintained at a temperature of 0˜5° C. and humidity of 20˜30% RH for 168 hrs.

After this step, the black garlic achieves the ideal chewy tissue-like quality and sweet and sour taste.

The black garlic produced via the above steps does not have the unique smell and hot taste of the raw garlic, which is now changed into the best black garlic with sweet and sour taste, chewy tissue feel, and easy handling and storability

What is claimed is:

1. A method of aging black garlic, involving the following steps:
classifying the garlic based on its condition and pre-treating it for a clean appearance;
sealing the garlic in a pack and storing it in a tray;
putting said tray in an aging device for a black garlic, applying steam of 100% RH humidity, and heat for 1˜3 hrs while maintaining a temperature of 80˜100° C.; and treating the garlic by steam under a high temperature and high humidity condition;
main aging by applying steam and heat to the treated garlic while maintaining the temperature of 72˜77° C. in the aging device;
after-aging by applying steam and heat to the garlic that has already undergone the main aging process while maintaining the temperature of 60˜69° C. in the aging device;
drying the after-aged garlic while maintaining the temperature of 50˜58° C. in the aging device; and
low temperature after-aging by cooling the dried garlic at 0˜5° C. in the aging device.

2. The method according to claim 1, wherein the garlic sealed in the pack is peeled garlic, the temperature of 72˜78° C. is maintained for 198 hrs at main aging stage, the temperature of 60˜69° C. is maintained for 35 hrs at after-aging stage, the temperature of 50˜58° C. is maintained for 51 hrs at drying stage, and a temperature of 0˜5° C. is maintained for 168 hrs at low temperature after-aging stage.

3. The method according to claim 1, wherein the humidity condition is kept at 60˜70% RH at main aging stage, 50˜60% RH is maintained at after-aging stage, 40˜50% RH is maintained at drying stage, and 20˜30% RH is maintained at low temperature after-aging.

4. The method according to claim 1, wherein while storing the garlic in the tray, its unique smell is neutralized by adding pine needles, red clay, or juniper into the said tray.

5. The method according to claim 1, wherein the garlic sealed in the pack is peeled garlic, the weight of the garlic is measured in said tray at each step and the weight decreases as follows:
weight change is measured at 0˜29% at steam treatment; 30˜49%, at main aging stage; 50˜54%, at after-aging stage; 55˜64%, at drying stage; and 65% or more, at low temperature after-aging stage.

6. The method according to claim 1, wherein the garlic sealed in the pack is unpeeled garlic, the weight of the garlic is measured in said tray at each step and the weight decreases as follows: weight change is measured at 0˜27% at steam treatment stage; 28˜46%, at main aging stage; 47˜51%, at after-aging stage; 52˜62%, at drying stage; and 63% or more, at low temperature after-aging stage.

7. The method according to claim 1, wherein the garlic sealed in the pack is unpeeled garlic, the temperature of 72˜78° C. is maintained for 140 hrs at main aging stage, the temperature of 60˜69° C. is maintained for 81 hrs at after-aging stage, the temperature of 50˜58° C. is maintained for 77 hrs at drying stage, and a temperature of 0˜5° C. is maintained for 168 hrs at low temperature after-aging stage.

8. The method according to claim 7, wherein the humidity condition is kept at 60˜70% RH at main aging stage, 50˜60% RH is maintained at after-aging stage, 40˜50% RH is maintained at drying stage, and 20˜30% RH is maintained at low temperature after-aging.

9. The method according to claim 7, wherein while storing the garlic in the tray, its unique smell is neutralized by adding pine needles, red clay, or juniper into the said tray.

10. The method according to claim 1, wherein the pack is vinyl and the garlic in the pack has a starting weight of 10 kg.

11. The method according to claim 7, wherein the pack is vinyl and the garlic in the pack has a starting weight of 10 kg.
